(19) United States
(12) Patent Application Publication
(10) Pub. No.: US 2014/0104394 A1
(43) Pub. Date: Apr. 17, 2014

(54) SYSTEM AND METHOD FOR COMBINING DATA FROM MULTIPLE DEPTH CAMERAS

(71) Applicant: INTEL CORPORATION, Santa clara, CA (US)

(72) Inventors: Yaron Yanai, Modiin (IL); Maoz Madmoni, Kibutz Bet Kamah (IL); Gilboa Levy, Tel Aviv (IL); Gershom Kutliroff, Alon Shvut (IL)

(73) Assignee: INTEL CORPORATION, Santa Clara, CA (US)

(21) Appl. No.: 13/652,181

(22) Filed: Oct. 15, 2012

(51) Int. Cl. H04N 13/02

(52) U.S. Cl. 348/47; 348/E13.074

(57) ABSTRACT

A system and method for combining depth images taken from multiple depth cameras into a composite image are described. The volume of space captured in the composite image is configurable in size and shape depending upon the number of depth cameras used and the shape of the cameras' imaging sensors. Tracking of movements of a person or object can be performed on the composite image. The tracked movements can subsequently be used by an interactive application.

### BACKGROUND

Depth cameras acquire depth images of their environments at interactive, high frame rates. The depth images provide pixel-wise measurements of the distance between objects within the field-of-view of the camera and the camera itself. Depth cameras are used to solve many problems in the general field of computer vision. As an example, depth cameras may be used as components of a solution in the surveillance industry, to track people and monitor access to prohibited areas. As an additional example, the cameras may be applied to HMI (Human-Machine Interface) problems, such as tracking people's movements and the movements of their hands and fingers.

Significant advances have been made in recent years in the application of gesture control for user interaction with electronic devices. Gestures captured by depth cameras can be used, for example, to control a television, for home automation, or to enable user interfaces with tablets, personal computers, and mobile phones. As the core technologies used in these cameras continue to improve and their costs decline, gesture control will continue to play an increasing role in human interactions with electronic devices.

### BRIEF DESCRIPTION OF THE DRAWINGS

Examples of a system for combining data from multiple depth cameras are illustrated in the figures. The examples and figures are illustrative rather than limiting.

FIG. 1 is a diagram illustrating an example environment in which two cameras are positioned to view an area.

FIG. 2 is a diagram illustrating an example environment in which multiple cameras are used to capture user interactions.

FIG. 3 is a diagram illustrating an example environment in which multiple cameras are used to capture interactions by multiple users.

FIG. 4 is a diagram illustrating two example input images and a composite synthetic image obtained from the input images.

FIG. 5 is a diagram illustrating an example model of a camera projection.

FIG. 6 is a diagram illustrating example fields of view of two cameras and a synthetic resolution line.

FIG. 7 is a diagram illustrating example fields of view of two cameras facing in different directions.

FIG. 8 is a diagram illustrating an example configuration of two cameras and an associated virtual camera.

FIG. 9 is a flow diagram illustrating an example process for generating a synthetic image.

FIG. 10 is a flow diagram illustrating an example process for processing data generated by multiple individual cameras and combining the data.

FIG. 11 is an example system diagram where input data streams from multiple cameras are processed by a central processor.

FIG. 12 is an example system diagram where input data streams from multiple cameras are processed by separate processors before being combined by a central processor.

FIG. 13 is an example system diagram where some camera data streams are processed by a dedicated processor while other camera data streams are processed by a host processor.

### DETAILED DESCRIPTION

A system and method for combining depth images taken from multiple depth cameras into a composite image are described. The volume of space captured in the composite image is configurable in size and shape depending upon the number of depth cameras used and the shape of the cameras' imaging sensors. Tracking of movements of a person or object can be performed on the composite image. The tracked movements can subsequently be used by an interactive application to render images of the tracked movements on a display.

Various aspects and examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

A depth camera is a camera that captures depth images, generally a sequence of successive depth images, at multiple frames per second. Each depth image contains per-pixel depth data, that is, each pixel in the image has a value that represents the distance between a corresponding area of an object in an imaged scene, and the camera. Depth cameras are sometimes referred to as three-dimensional (3D) cameras. A depth camera may contain a depth image sensor, an optical lens, and an illumination source, among other components. The depth image sensor may rely on one of several different sensor technologies. Among these sensor technologies are time-of-flight, known as “TOF”, (including scanning TOF or array TOF), structured light, laser speckle pattern technology, stereoscopic cameras, active stereoscopic sensors, and shape-from-shading technology. Most of these techniques rely on active sensors, in the sense that they supply their own illumination source. In contrast, passive sensor techniques, such as stereoscopic cameras, do not supply their own illumination source, but depend instead on ambient environmental lighting. In addition to depth data, the cameras may also generate color data, in the same way that conventional color cameras do, and the color data can be combined with the depth data for processing.

The field-of-view of a camera refers to the region of a scene that a camera captures, and it is a function of several components of the camera, including, for example, the shape and curvature of the camera lens. The resolution of the camera is the number of pixels in each image that the camera captures. For example, the resolution may be 320×240 pixels, that is, 320 pixels in the horizontal direction, and 240 pixels in the vertical direction. Depth cameras can be configured for different ranges. The range of a camera is the region in front of the camera in which the camera captures data of a minimal quality, and is, generally speaking, a function of the camera's component specifications and assembly. In the case of time-of-flight cameras, for example, longer ranges typically require higher illumination power. Longer ranges may also require higher pixel array resolutions.

There is a direct tradeoff between the quality of the data generated by a depth camera, and parameters of the camera such as the field-of-view, resolution, and frame rate. The quality of the data, in turn, determines the level of movement tracking that the camera can support. In particular, the data must conform to a certain level of quality in order to enable robust and highly precise tracking of a user's fine movements. Since the camera specifications are effectively limited by considerations of cost and size, the quality of the data is likewise limited. Furthermore, there are additional restrictions that also affect the character of the data. For example, the specific geometric shape of the image sensor (generally rectangular) defines the dimensions of the image captured by the camera.

An interaction area is the space in front of a depth camera in which a user can interact with an application, and, consequently, the quality of the data generated by the camera should be high enough to support tracking of the user's movements. The interaction area requirements of different applications may not be satisfied by the specifications of the camera. For example, if a developer intends to construct an installation in which multiple users can interact, a single camera's field-of-view may be too limiting to support the entire interaction area necessary for the installation. In another example, the developer may want to work with an interaction space that is different than the shape of the interaction area specified by the camera, such as an L-shape, or a circular-shaped interaction area. The disclosure describes how the data from multiple depth cameras can be combined, via specialized algorithms, so as to enlarge the area of interaction and customize it to fit the particular needs of the application.

The term “combining the data” refers to a process that takes data from multiple cameras, each with a view of a portion of the interaction area, and produces a new stream of data that covers the entire interaction area. Cameras having various ranges can be used to obtain the individual streams of depth data, and even multiple cameras that each have a different range can be used. The data, in this context, can refer either to raw data from the cameras, or to the output of tracking algorithms that are individually run on raw camera data. Data from multiple cameras can be combined even if the cameras do not have overlapping fields-of-view.

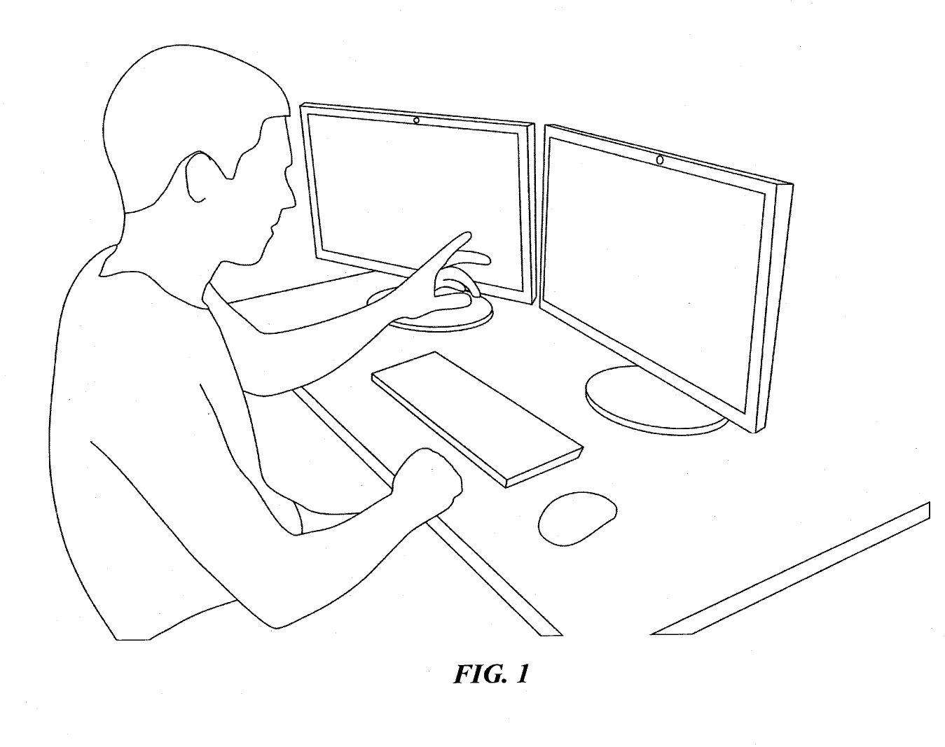

There are many situations in which it is desirable to extend the interaction area for applications that require the use of depth cameras. Refer to FIG. 1, which is a diagram of one embodiment, in which a user may have two monitors at his desk, with two cameras, each camera positioned to view the area in front of one screen. Because of both the proximity of the camera to the user's hands, and the quality of the depth data required to support highly precise tracking of the user's fingers, it is not generally possible for one camera's field-of-view to cover the entire desired interaction area. Rather, the independent data streams from each camera can be combined to generate a single, synthetic data stream, and tracking algorithms can be applied to this synthetic data stream. From the perspective of the user, he is able to move his hands from one camera's field-of-view into that of the second camera, and his application reacts seamlessly, as if his hand stayed within the field-of-view of a single camera. For example, the user may pick up a virtual object that is visible on a first screen with his hand, and move his hand in front of the camera associated with a second screen, where he then releases the object, and the object appears on the second screen.

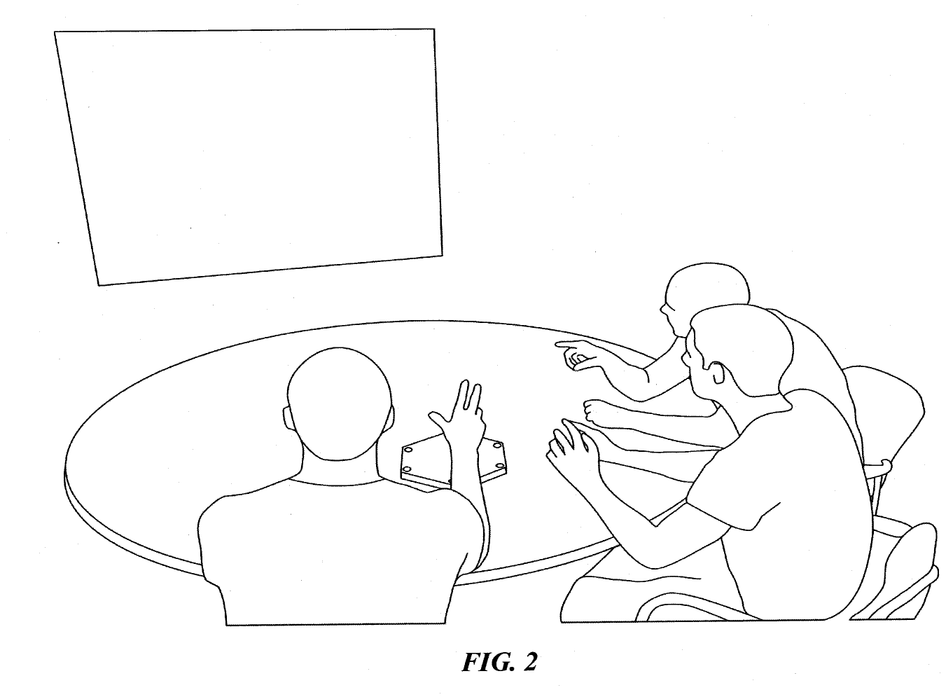

FIG. 2 is a diagram of another example embodiment in which a standalone device can contain multiple cameras positioned around its periphery, each with a field-of-view that extends outward from the device. The device can be placed, for example, on a conference table, where several people may be seated, and can capture a unified interaction area.

In an additional embodiment, several individuals may work together, each on a separate device. Each device may be equipped with a camera. The fields-of-view of the individual cameras can be combined to generate a large, composite interaction area accessible to all the individual users together. The individual devices may even be different kinds of electronic devices, such as laptops, tablets, desktop personal computers, and smart phones.

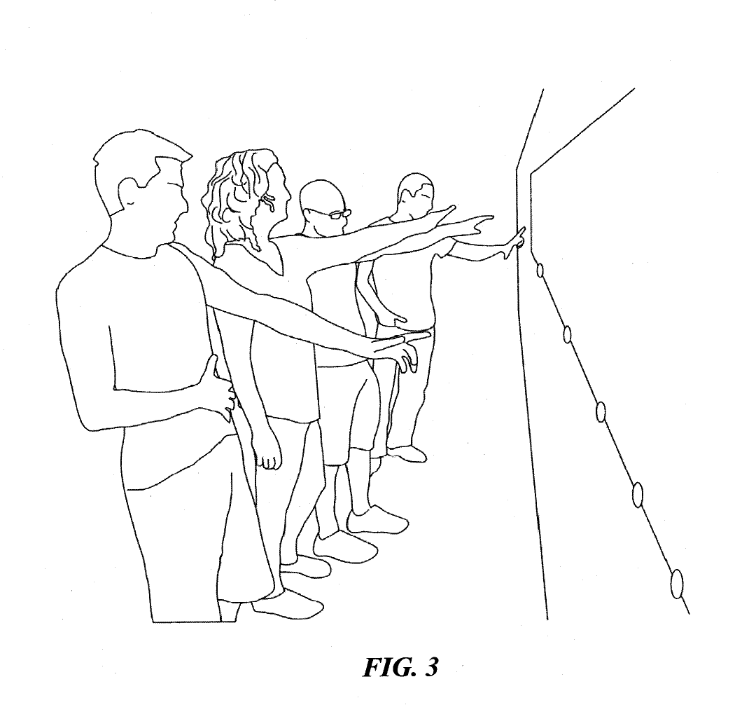

FIG. 3 is a diagram of a further example embodiment which is an application designed for simultaneous interaction by multiple users. Such an application might appear, for example, in a museum, or in another type of public space. In this case, there may be a particularly large interaction area for an application designed for multi-user interaction. In order to support this application, multiple cameras can be installed so that their respective fields-of-view overlap with each other, and the data from each one can be combined into a composite synthetic data stream that can be processed by the tracking algorithms. In this way, the interaction area can be made arbitrarily large, to support any such applications.

In all of the aforementioned embodiments, the cameras may be depth cameras, and the depth data they generate may be used to enable tracking and gesture recognition algorithms that are able to interpret a user's movements. U.S. patent application Ser. No. 13/532,609, entitled “SYSTEM AND METHOD FOR CLOSE-RANGE MOVEMENT TRACKING”, filed Jun. 25, 2012, describes several types of relevant user interactions based on depth cameras, and is hereby incorporated in its entirety.

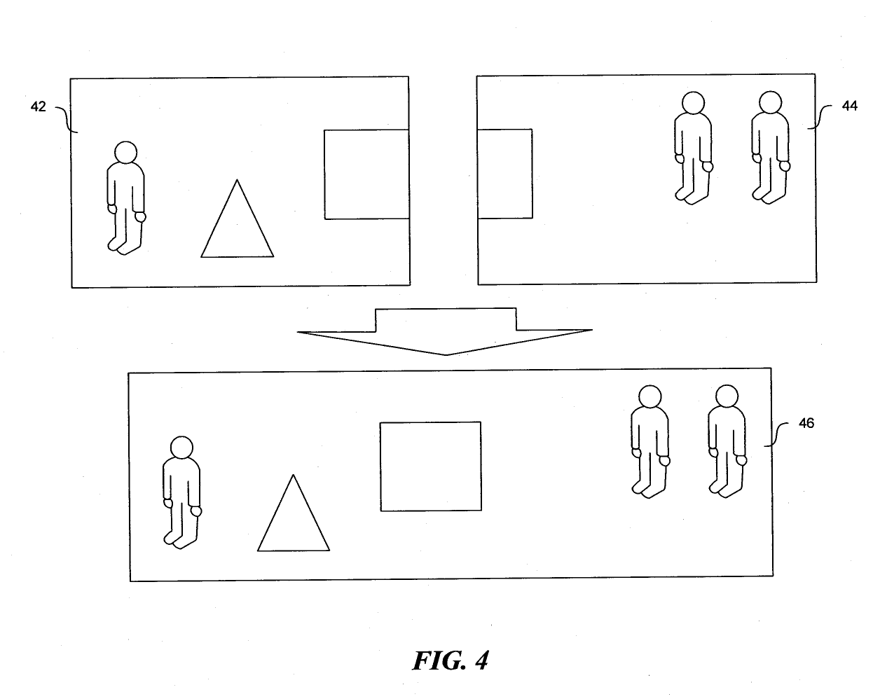

FIG. 4 is a diagram of an example of two input images, 42 and 44, captured by separate cameras, positioned a fixed distance apart from each other, and the synthetic image 46, that is created by combining the data from the two input images using the techniques described in this disclosure. Note that the objects in the individual input images 42 and 44 appear in their respective locations in the synthetic image, as well.

Cameras view a three-dimensional (3D) scene and project objects from the 3D scene onto a two-dimensional (2D) image plane. In the context of the discussion of the camera projection, “image coordinate system” refers to the 2D coordinate system (x, y) associated with the image plane, and “world coordinate system” refers to the 3D coordinate system (X, Y, Z) associated with the scene that the camera is viewing. In both coordinate systems, the camera is at the origin ((x=0, y=0), or (X=0, Y=0, Z=0)) of the coordinate axes.

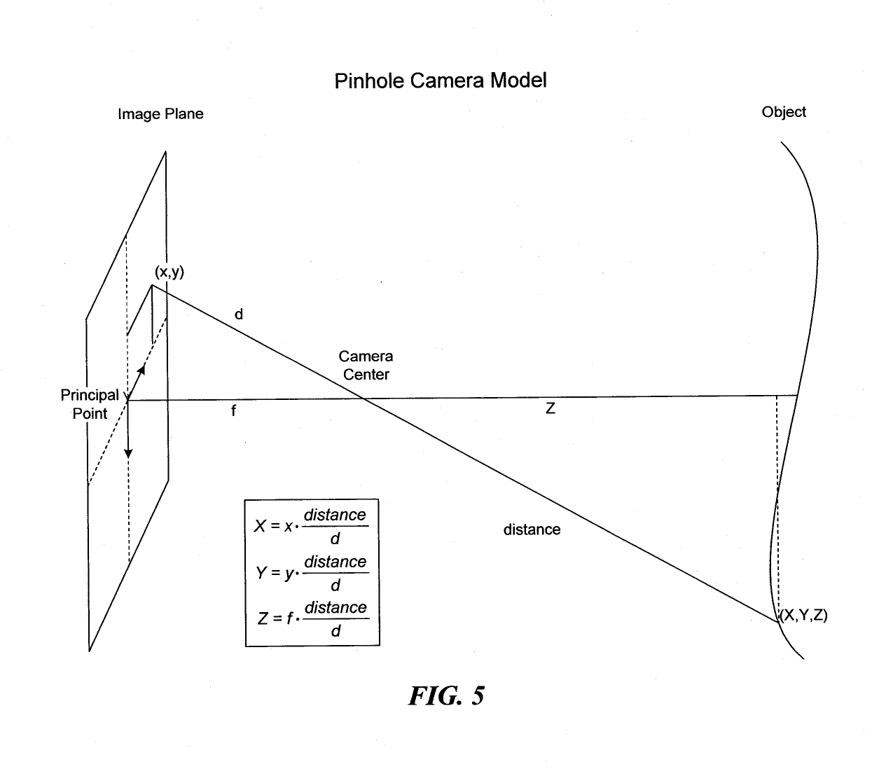

Refer to FIG. 5, which is an example idealized model of a camera projection process, known as a pinhole camera model. Since the model is idealized, for the sake of simplicity, certain characteristics of the camera projection, such as the lens distortion, are ignored. Based on this model, the relation between the 3D coordinate system of the scene, (X, Y, Z), and the 2D coordinate system of the image plane, (x, y), is:

$$X = x ( \frac{distance}{d} ) , \\ Y = y ( \frac{distance}{d} ) , \\ Z = f ( \frac{distance}{d} ) ,$$

where distance is the distance between the camera center (also called the focal point) and a point on the object, and d is the distance between the camera center and the point in the image corresponding to the projection of the object point. The variable f is the focal length and is the distance between the origin of the 2D image plane and the camera center (or focal point). Thus, there is a one-to-one mapping between points in the 2D image plane and points in the 3D world. The mapping from the 3D world coordinate system (the real world scene) to the 2D image coordinate system (the image plane) is referred to as the projection function, and the mapping from the 2D image coordinate system to the 3D world coordinate system is referred to as the back-projection function.

The disclosure describes a method of taking two images, captured at nearly the same instant in time, one from each of two depth cameras, and constructing a single image, which we will refer to as the “synthetic image”. For the sake of simplicity, the current discussion will focus on the case of two cameras. Obviously, the methods discussed herein are easily extensible to the case in which more than two cameras are used.

Initially, the respective projection and back-projection functions for each depth camera are computed.

The technique further involves a virtual camera which is used to virtually “capture” the synthetic image. The first step in the construction of this virtual camera is to derive its parameters—its field-of-view, resolution, etc. Subsequently, the projection and back-projection functions of the virtual camera are also computed, so that the synthetic image can be treated as if it were a depth image captured by a single, “real” depth camera. Computation of the projection and back-projection functions for the virtual camera depends on camera parameters such as the resolution and the focal length.

The focal length of the virtual camera is derived as a function of the focal lengths of the input cameras. The function may be dependent upon the placement of the input cameras, for example, whether the input cameras are facing in the same direction. In one embodiment, the focal length of the virtual camera can be derived as an average of the focal lengths of the input cameras. Typically, the input cameras are of the same type and have the same lenses, so the focal lengths of the input cameras are very similar. In this case, the focal length of the virtual camera is the same as that of the input cameras.

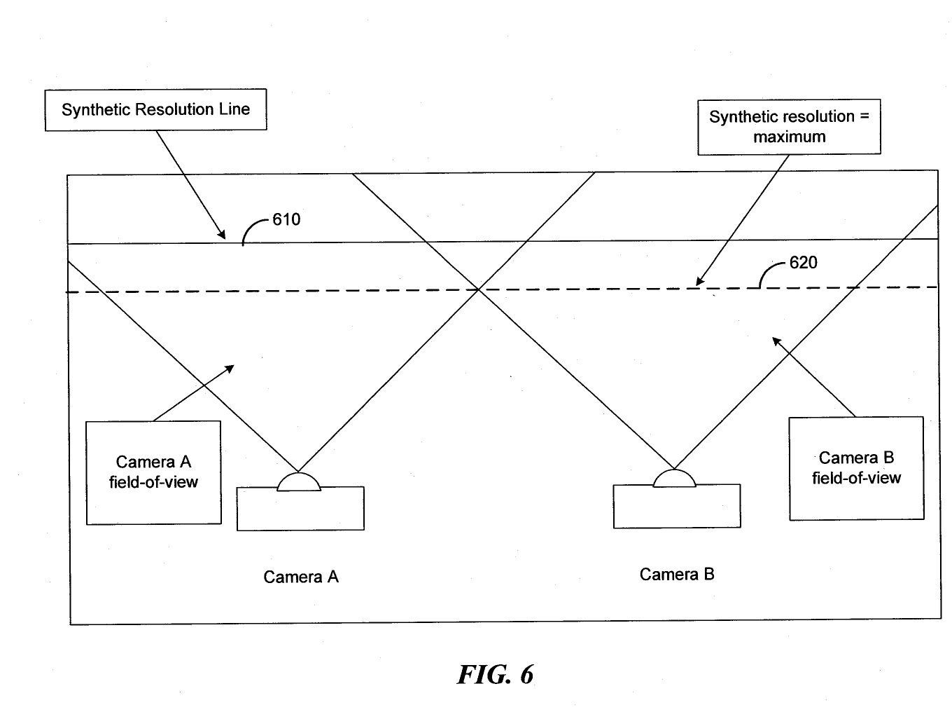

The resolution of a synthetic image, generated by the virtual camera, is derived from the resolutions of the input cameras. The resolution of the input cameras are fixed, so the larger the overlap of the images acquired by the input cameras, the less non-overlapping resolution is available from which to create the synthetic image. FIG. 6 is a diagram of two input cameras, A and B, in parallel, so that they are facing in the same direction and positioned a fixed distance apart. The field-of-view of each camera is represented by the cones extending from the respective camera lenses. As an object moves farther away from the camera, a larger region of that object is represented as a single pixel. Thus, the granularity of an object that is farther away is not as fine as the granularity of the object when it is closer to the camera. In order to complete the model of the virtual camera, an additional parameter must be defined, which relates to the depth region of interest for the virtual camera.

In FIG. 6 there is a straight line 610 in the diagram, parallel to the axis on which the two cameras A and B are positioned, which is labeled “synthetic resolution line”. The synthetic resolution line intersects the fields-of-view of both cameras. This synthetic resolution line can be adjusted, based on the desired range of the application, but it is defined relative to the virtual camera, for example, as being perpendicular to a ray extending from the center of the virtual camera. For the scenario depicted in FIG. 6, the virtual camera can be placed at a midpoint, i.e., symmetrically, between the input cameras A and B to maximize the synthetic image that would be captured by the virtual camera. The synthetic resolution line is used to establish the resolution of the synthetic image. In particular, the further away the synthetic resolution line is set from the cameras, the lower the resolution of the synthetic image, since larger regions of the two images overlap. Similarly, as the distance between the synthetic resolution line and the virtual camera decreases, the resolution of the synthetic image increases. In the case where the cameras are placed in parallel, and only separated by translation, as in FIG. 6, there is a line 620 in the diagram denoted as “synthetic resolution=maximum”. If the synthetic resolution line of the virtual camera is selected to be line 620, the resolution of the synthetic image is maximal, and it is equal to the sum of the resolutions of cameras A and B. In other words, the maximal possible resolution is obtained where there is a minimum intersection of the fields of view of the input cameras. The synthetic resolution line can be fixed on an ad hoc basis by the user, depending on the region of interest of the application.

The synthetic resolution line shown in FIG. 6 is for a limited case where, for simplicity, it is constrained to be linear and parallel to the axis on which the input cameras and the virtual camera are situated. A synthetic resolution line subject to these constraints is still sufficient for defining the resolution of the virtual camera for many cases of interest. However, more generally, the synthetic resolution line of the virtual camera can be a curve or made up of multiple piecewise linear segments that are not in a straight line.

Associated with each of the input cameras, for example, cameras A and B in FIG. 6, is an independent coordinate system. It is straightforward to compute the transformation between these respective coordinate systems. The transformation maps one coordinate system to another, and provides a way to assign to any point in a first coordinate system, respectively, a value in the second coordinate system.

In one embodiment, the input cameras (A and B) have overlapping fields-of-view. However, without any loss of generality, the synthetic image can also be constructed of multiple input images that do not overlap such that there are gaps in the synthetic image. The synthetic image can still be used for tracking movements. In this case, the positions of the input cameras would be need to be computed explicitly because the images generated by the cameras do not overlap.

For the case of overlapping images, computing this transformation can be done by matching features between images from the two cameras, and solving the correspondence problem. Alternatively, if the cameras' positions are fixed, there can be an explicit calibration phase, in which points appearing in images from both cameras are manually marked, and the transformation between the two coordinate systems can be computed from these matched points. Another alternative is to define the transformation between the respective cameras' coordinate systems explicitly. For example, the relative positions of the individual cameras may be entered by the user as part of the system initialization process, and the transformation between the cameras can be computed. This method of specifying the spatial relationship between the two cameras explicitly, by the user, is useful, for example, in the case when the input cameras, do not have overlapping fields-of-view. No matter which method is used to derive the transformation between different cameras (and their respective coordinate systems), this step only needs to be done once, for example, at the time that the system is configured. As long as the cameras are not moved, the transformation computed between the cameras' coordinate systems is valid.

Additionally, identifying the transformations between each of the input cameras defines the input cameras' positions with respect to each other. This information can be used to identify the midpoint or a position that is symmetrical with respect to the positions of the input cameras for the virtual camera to be located. Alternatively, the input cameras' positions can be used to select any other position for the virtual camera based upon other application-specific requirements for the synthetic image. Once the position of the virtual camera is fixed, and the synthetic resolution line is selected, the resolution of the virtual camera can be derived.

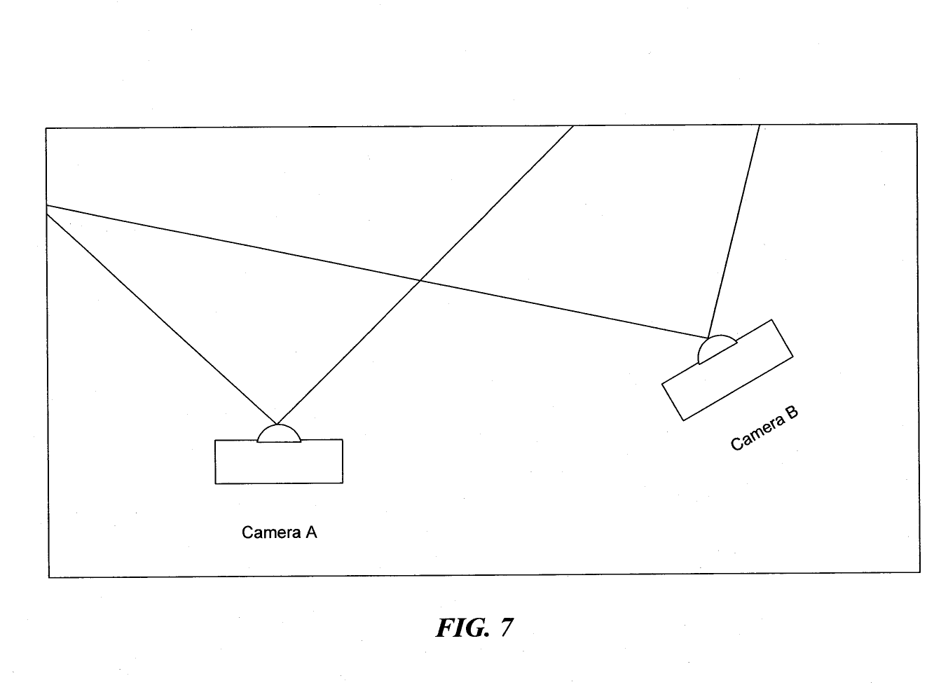

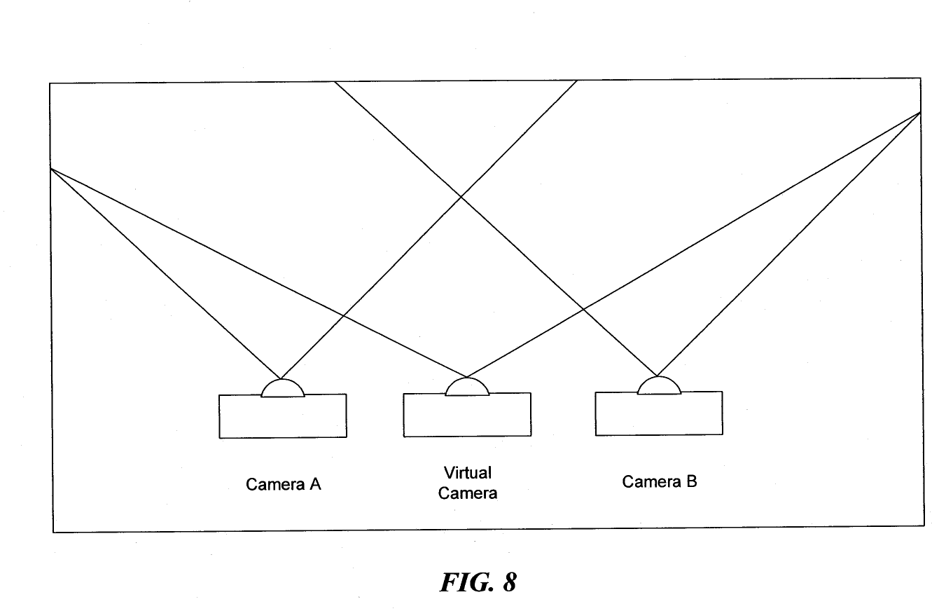

The input cameras can be placed in parallel, as in FIG. 6, or with a more arbitrary relationship, as in FIG. 7. FIG. 8 is a sample diagram of two cameras, a fixed distance apart, with a virtual camera positioned at the midpoint between the two cameras. However, the virtual camera can be positioned anywhere with respect to the input cameras.

In one embodiment, the data from multiple input cameras can be combined to produce the synthetic image, which is an image that is associated with the virtual camera. Before beginning to process the images from the input cameras, several characteristics of the virtual camera must be computed. First, the virtual camera “specs”—resolution, focal length, projection function, and back-projection function, as described above—are computed. Subsequently, the transformations from the coordinate systems of each of the input cameras to the virtual camera are computed. That is, the virtual camera acts as if it is a real camera, and generates a synthetic image which is defined by the specs of the camera, in a manner similar to the way actual cameras generate images.

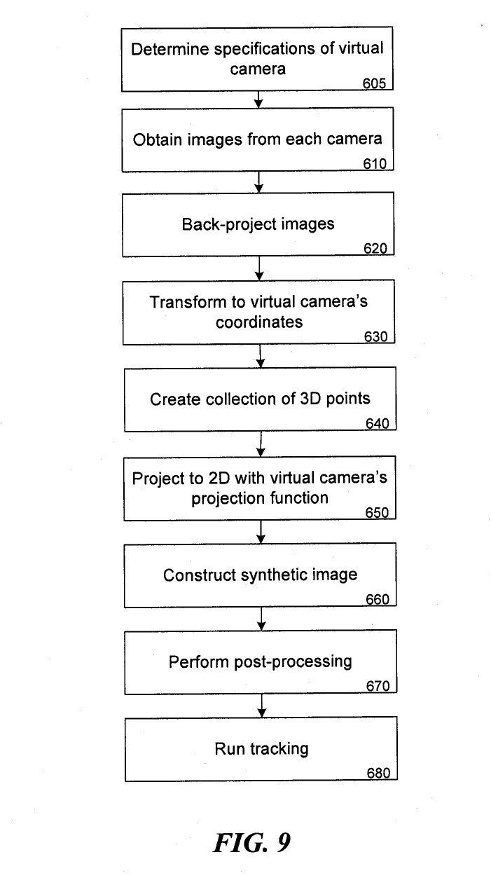

FIG. 9 describes an example workflow for generating a synthetic image from a virtual camera using multiple input images generated by multiple input cameras. First, at 605, the specifications, e.g. resolution, focal length, synthetic resolution line, etc., of the virtual camera are computed as well as the transformations from the coordinate systems of each of the input cameras to the virtual camera.

Then at 610, the depth images are captured by each input camera independently. It is assumed that the images are captured at nearly the same instant. If this is not the case, they must be explicitly synchronized to ensure that they both reflect the projection of the scene at the same point in time. For example, checking the timestamp of each image and selecting images with timestamps within a certain threshold can suffice to satisfy this requirement.

Subsequently, at 620, each 2D depth image is back-projected to the 3D coordinate system of each camera. Each set of 3D points are then transformed to the coordinate system of the virtual camera at 630 by applying the transformation from the respective camera's coordinate system to the coordinate system of the virtual camera. The relevant transformation is applied to each data point independently. Based on the determination of the synthetic resolution line, as described above, a collection of three-dimensional points reproducing the area monitored by the input cameras is created at 640. The synthetic resolution line determines the region in which the images from the input cameras overlap

Using the virtual camera's projection function, each of the 3D points is projected onto a 2D synthetic image at 650. Each pixel in the synthetic image corresponds to either a pixel in one of the camera images, or to two pixels in the case of two input cameras, one from each camera image. In the case that the synthetic image pixel corresponds to only a single camera image pixel, it receives the value of that pixel. In the case that the synthetic image pixel corresponds to two camera image pixels (i.e., the synthetic image pixel is in the region in which the two camera images overlap), the pixel with the minimum value should be selected to construct the synthetic image 660. The reason is because a smaller depth pixel value means the object is closer to one of the cameras, and this scenario may arise when the camera with the minimum pixel value has a view of an object that the other camera does not have. If both cameras image the same point on the object, the pixel value for each camera for that point, after it is transformed to the virtual camera's coordinate system, should be nearly the same. Alternatively or additionally, any other algorithm, such as an interpolation algorithm, can be applied to the pixel values of the acquired images to help fill in missing data or improve the quality of the synthetic image.

Depending on the relative positions of the input cameras, the synthetic image may contain invalid, or noisy, pixels, resulting from the limited resolution of the input camera images, and the process of projecting an image pixel to a real-world, 3D point, transforming the point to the virtual camera's coordinate system, and then back-projecting the 3D point to the 2D, synthetic image. Consequently, a post-processing cleaning algorithm should be applied at 670 to clean up the noisy pixel data. Noisy pixels appear in the synthetic image because there are no corresponding 3D points in the data that was captured by the input cameras, after it was transformed to the coordinate system of the virtual camera. One solution is to interpolate between all the pixels in the actual camera images, in order to generate an image of much higher resolution, and, consequently, a much more dense cloud of 3D points. If the 3D point cloud is sufficiently dense, all of the synthetic image pixels will correspond to at least one valid (i.e., captured by an input camera) 3D point. The downside of this approach is the cost of sub-sampling to create a very high resolution image from each input camera and the management of a high volume of data.

Consequently, in an embodiment of the current disclosure, the following technique is applied to clean up the noisy pixels in the synthetic image. First, a simple 3×3 filter (e.g., a median filter) is applied to all the pixels in the depth image, in order to exclude depth values that are too large. Then, each pixel of the synthetic image is mapped back into the respective input camera images, as follows: each image pixel of the synthetic image is projected into 3D space, the respective reverse transformation is applied to map the 3D point into each input camera, and finally, each input camera's back-projection function is applied to the 3D point, in order to map the point to the input camera image. (Note that this is exactly the reverse of the process that was applied in order to create the synthetic image in the first place.) In this way, either one or two pixel values are obtained, from either one or both input cameras (depending on whether the pixel is on the overlapping region of the synthetic image). If two pixels are obtained (one from each input camera), the minimum value is selected, and, after it is projected, transformed, and back-projected, assigned to the “noisy” pixel of the synthetic image.

Once the synthetic image is constructed, at 680, tracking algorithms can be run on it, in the same way that they can be run on standard depth images generated by depth cameras. In one embodiment, tracking algorithms are run on the synthetic image to track the movements of people, or the movements of the fingers and hands, to be used as input to an interactive application.

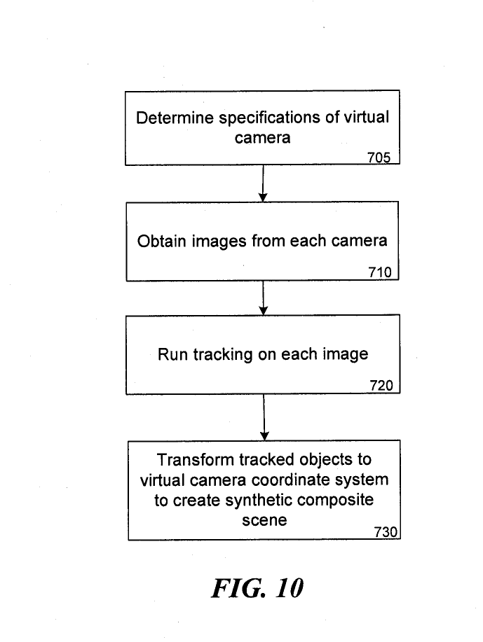

FIG. 10 is an example workflow of an alternative method for processing the data generated by multiple individual cameras and to combine the data. In this alternative method, a tracking module is run individually on the data generated by each camera, and the results of the tracking modules are then combined together. Similar to the method described by FIG. 9, at 705 the specifications of the virtual camera are computed, and the relative positions of the individual cameras are first acquired and the transformations between the input cameras and the virtual camera are derived. Images are captured separately by each input camera at 710, and the tracking algorithms are run on each input camera's data at 720. The output of the tracking module includes the 3D positions of the tracked objects. Objects are transformed from the coordinate system of their respective input camera to the coordinate system of the virtual camera, and a 3D composite scene is created synthetically at 730. Note that the 3D composite scene created at 730 is different from the synthetic image that is constructed at 660 in FIG. 9. In one embodiment, this composite scene is used to enable interactive applications. This process can similarly be performed for a sequence of images received from each of the multiple input cameras so that a sequence of composite scenes is created synthetically.

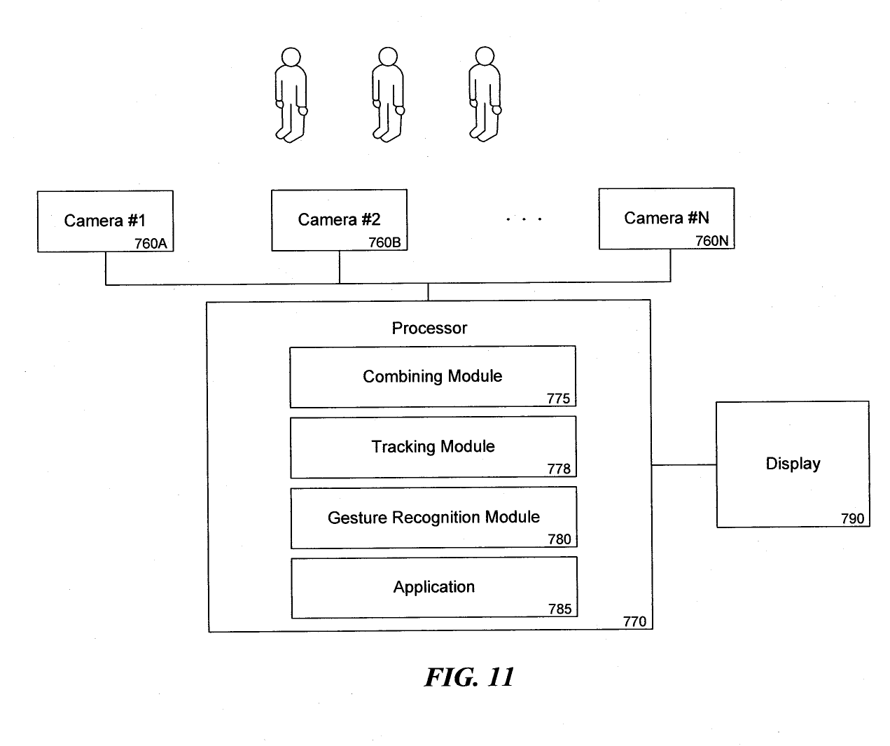

FIG. 11 is a diagram of an example system that can apply the techniques discussed herein. In this example, there are multiple (“N”) cameras, 760A, 760B, . . . 760N imaging a scene. The data streams from each of the cameras are sent to processor 770, and the combining module 775 takes the input data streams from the individual cameras and generates a synthetic image from them, using the process described by the flow diagram in FIG. 9. The tracking module 778 applies tracking algorithms to the synthetic image, and the output of the tracking algorithms may be used by the gesture recognition module 780 to recognize gestures that have been performed by a user. The output of the tracking module 778 and the gesture recognition module 780, are sent to the application 785, which communicates with the display 790 to present feedback to the user.

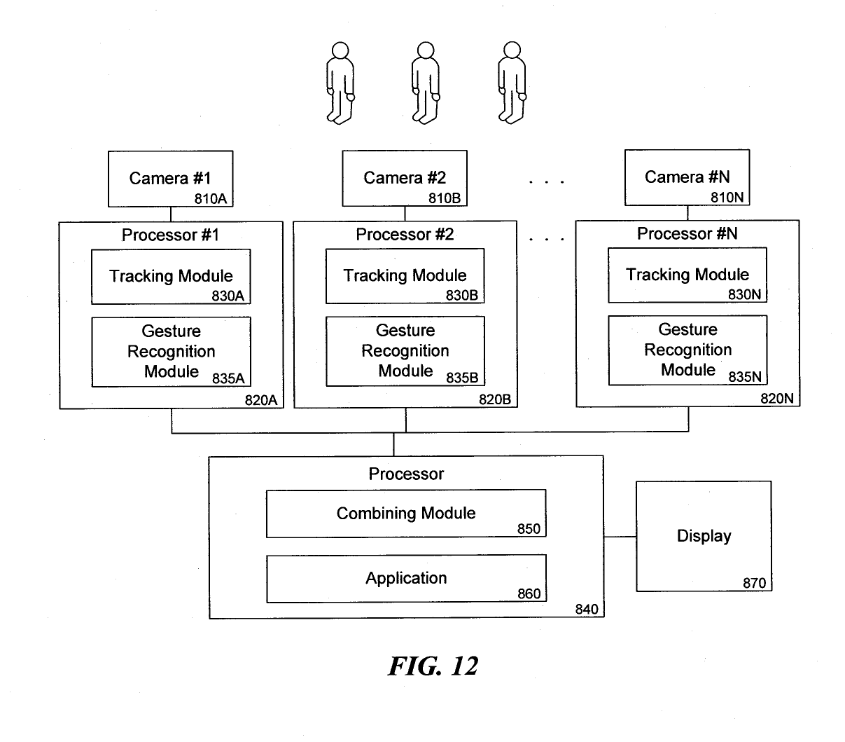

FIG. 12 is a diagram of an example system in which the tracking modules are run separately on the data streams generated by the individual cameras, and the output of the tracking data is combined to produce the synthetic scene. In this example, there are multiple (“N”) cameras, 810A, 810B, . . . 810N. Each camera is connected to a separate processor, 820A, 8208, . . . 820N, respectively. The tracking modules 830A, 830B, . . . 830N are run individually on the data streams generated by the respective cameras. Optionally, a gesture recognition module 835A, 835B, . . . 835N can also be run on the output of the tracking modules 830A, 830B, . . . 830N. Subsequently, the results of the individual tracking modules 830A, 830B, . . . 830N and the gesture recognition modules 835A, 835B, . . . 835N are transferred to a separate processor, 840, which applies the combining module 850. The combining module 850 receives as input the data generated by the individual tracking modules 830A, 830B, . . . 830N and creates a synthetic 3D scene, according to the process described in FIG. 10. The processor 840 may also execute an application 860 which receives the input from the combining module 850 and the gesture recognition modules 835A, 835B, . . . 835N and may render images that can be displayed to the user on the display 870.

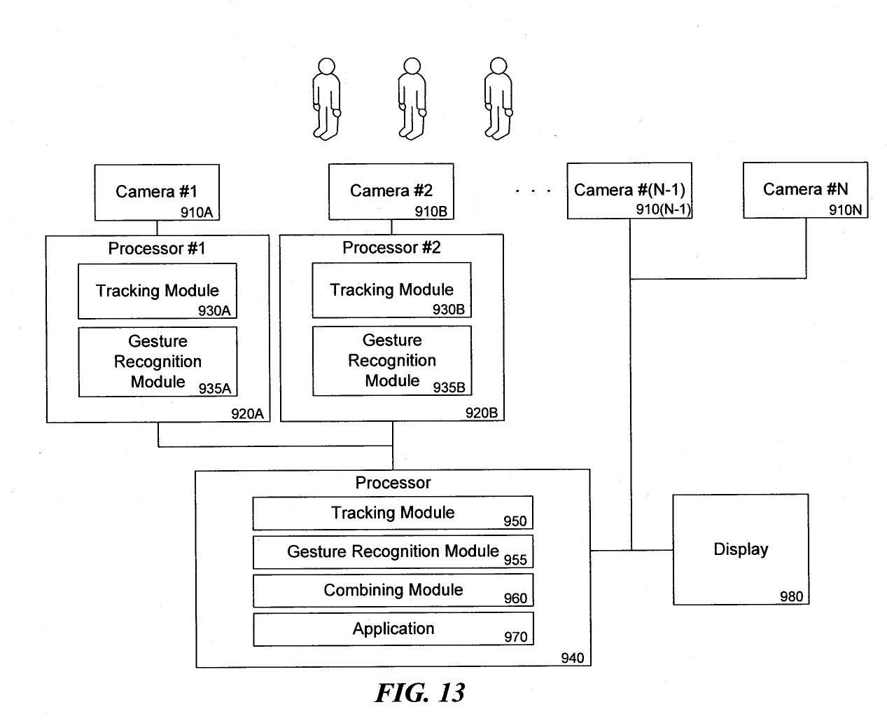

FIG. 13 is a diagram of an example system in which some tracking modules are run on processors dedicated to individual cameras, and others are run on a “host” processor. Cameras 910A, 910B, . . . 910N capture images of an environment. Processors 920A, 920B receive the images from the cameras 910A, 910B, respectively, and tracking modules 930A, 930B run tracking algorithms, and, optionally, gesture recognition modules 935A, 935B run gesture recognition algorithms. Some of the cameras 910(N−1), 910N pass the image data streams directly to the “host” processor 940, which runs the tracking module 950, and, optionally, the gesture recognition module 955, on the data streams generated by cameras 910(N−1),910N. The tracking module 950 is applied to the data streams generated by the cameras that are not connected to a separate processor. The combining module 960 receives as input the outputs of the various tracking modules 930A, 930B, 950, and combines them all into a synthetic 3D scene according to the process shown in FIG. 10. Subsequently, the tracking data and identified gestures may be transferred to an interactive application 970 which may use a display 980 to present feedback to the user.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention.

We claim:

1. A system comprising:
a plurality of depth cameras, wherein each depth camera is configured to capture a sequence of depth images of a scene over a period of time;
a plurality of individual processors, wherein each individual processor is configured to:
receive a respective sequence of depth images from a respective one of the plurality of depth cameras;
track movements of one or more persons or body parts in the sequence of depth images to obtain three-dimensional positions of the tracked one or more persons or body parts;
a group processor configured to:
receive the three-dimensional positions of the tracked one or more persons or body parts from each of the individual processors;
generate a sequence of composite three-dimensional scenes from the three dimensional positions of the tracked persons or one or more body parts.

2. The system of claim 1, further comprising an interactive application, wherein the interactive application uses the movements of the tracked one or more persons or body parts as an input.

3. The system of claim 2, wherein each individual processor is further configured to identify one or more gestures from the tracked movements, and further wherein the group processor is further configured to receive the identified one or more gestures, and the interactive application relies on the gestures for control of the application.

4. The system of claim 1, wherein generating the sequence of composite three-dimensional scenes comprises:
deriving parameters and a projection function of a virtual camera;
using information about relative positions of the plurality of depth cameras to derive transformations between the plurality of depth cameras and the virtual camera;
transforming the movements to a coordinate system of the virtual camera.

5. The system of claim 1, further comprising an additional plurality of depth cameras, wherein each of the additional plurality of depth cameras is configured to capture an additional sequence of depth images of the scene over the period of time,
wherein the group processor is further configured to:
receive the additional sequence of depth images from each of the additional plurality of depth cameras;
track movements of the one or more persons or body parts in the additional sequences of depth images to obtain three-dimensional positions of the tracked one or more persons or body parts,
wherein the sequence of the composite three-dimensional scenes is further generated from the three-dimensional positions of the tracked one or more persons or body parts in the additional sequence of depth images.

6. The system of claim 5, wherein the group processor is further configured to identify one or more additional gestures from the tracked one or more persons or body parts in the additional sequence of depth images.

7. A system comprising:
a plurality of depth cameras, wherein each depth camera is configured to capture a sequence of depth images of a scene over a period of time;
a group processor configured to:
receive the sequences of depth images from the plurality of depth cameras;
generate a sequence of synthetic images from the sequences of depth images, wherein each synthetic image in the sequence of synthetic images corresponds to one of the depth images in the sequence of depth images from each of the plurality of depth cameras;
track movements of one or more persons or body parts in the sequence of synthetic images.

8. The system of claim 7, further comprising an interactive application, wherein the interactive application uses the movements of the tracked one or more persons or body parts as an input.

9. The system of claim 8, wherein the group processor is further configured to identify one or more gestures from the tracked movements of the one or more persons or body parts, and further wherein the interactive application uses the gestures for control of the application.

10. The system of claim 7, wherein generating the sequence of synthetic images from the sequences of depth images comprises:
deriving parameters and a projection function of a virtual camera for virtually capturing the synthetic images;
back-projecting each of the corresponding depth images received from the plurality of depth cameras;
transforming the back-projected images to a coordinate system of the virtual camera;
using the projection function of the virtual camera to project each of the transformed back-projected images to the synthetic image.

11. The system of claim 10, wherein generating the sequence of synthetic images from the sequences of depth images further comprises applying a post-processing algorithm to clean the synthetic images.

12. A method of generating a synthetic depth image using a depth image captured from each one of a plurality of depth cameras, the method comprising:
deriving parameters for a virtual camera capable of virtually capturing the synthetic depth image, wherein the parameters include a projection function that maps objects from a three-dimensional scene to an image plane of the virtual camera;
back-projecting each depth image to a set of three-dimensional points in a three-dimensional coordinate system of each respective depth camera;
transforming each set of back-projected three-dimensional points to a coordinate system of the virtual camera;
projecting each transformed set of back-projected three-dimensional points to the two-dimensional synthetic image.

13. The method of claim 12, further comprising applying a post-processing algorithm to clean the synthetic depth image.

14. The method of claim 12, further comprising running a tracking algorithm on a series of obtained synthetic depth images, wherein tracked objects are used as input to an interactive application.

15. The method of claim 14, wherein the interactive application renders images based on the tracked objects on a display to provide feedback to a user.

16. The method of claim 14, further comprising identifying gestures from the tracked objects, wherein the interactive application renders images based on the tracked objects and identified gestures on a display to provide feedback to a user.

17. A method of generating a sequence of composite three-dimensional scenes from a plurality of sequences of depth images, wherein each of the plurality of sequences of depth images is taken by a different depth camera, the method comprising:
tracking movements of one or more persons or body parts in each of the sequences of depth images;
deriving parameters for a virtual camera, wherein the parameters include a projection function that maps objects from a three-dimensional scene to an image plane of the virtual camera;
using information about relative positions of the depth cameras to derive transformations between the depth cameras and the virtual camera;
transforming the movements to a coordinate system of the virtual camera.

18. The method of claim 17, further comprising using the tracked movements of the one or more persons or body parts as an input to an interactive application.

19. The method of claim 18, further comprising identifying gestures from the tracked movements of the one or more persons or body parts, wherein the identified gestures control the interactive application.

20. The method of claim 19, wherein the interactive application renders images on a display of the identified gestures to provide feedback to a user.
